(19) United States
(12) Patent Application Publication
(10) Pub. No.: US 2025/0098565 A1
(43) Pub. Date: Mar. 27, 2025

(54) Agricultural Implement Having Row Unit Supports and Alignment Pins, and Related Method of Configuring Such Implement

(71) Applicant: AGCO do Brasil Soluções Agrícolas Ltda., Jundiaí (BR)

(72) Inventors: Jarlis Luiz Matter, Ibirubá (BR); Venicius Damo Cunha, Não Me Toque (BR); Leandro Burghausen, Ibirubá (BR)

(21) Appl. No.: 18/832,262

(22) PCT Filed: Feb. 15, 2023
(86) PCT No.: PCT/IB2023/051364

§ 371 Date: Jul. 23, 2024

(30) Foreign Application Priority Data
Mar. 4, 2022 (GB) 2202999.5

(51) Int. Cl. A01C 7/20

(52) U.S. Cl. CPC A01C 7/201

(57) ABSTRACT

An agricultural implement (104) includes a toolbar (114), a plurality of receivers (202) fixed to the toolbar, a plurality of row unit supports, and a plurality of alignment pins (212). Each receiver defines a notch (302) and a through-hole (304), and each row unit support includes a shaft (306) and defines a through-hole (310). The through-hole of the row unit support is configured to align with the through-hole of a respective receiver when the shaft rests in the notch of the respective receiver. Each alignment pin is configured to lock a row unit support to the respective receiver when the through-holes are aligned and the shaft rests in the notch. Methods of configuring an implement (e.g., changing row unit spacing) are also disclosed.

### FIELD

Embodiments of the present disclosure relate generally to planters and other agricultural equipment, and in particular, row units that can be adjusted to be at different lateral positions along a toolbar.

### BACKGROUND

Agricultural machines such as planters with a plurality of row units are used to plant seeds upon or in the ground. Planters may have a central portion pulled by a tractor, and may have wings extending from either side. The individual row units, mounted to the center section or to a wing, typically deliver seeds into separate rows. The row units may receive seed from a common central hopper, which may be used to limit the effect of excessive weight on the wings. That is, the center section may be supported by more wheels or larger wheels, and thus may be better able to support the weight of the filled central hopper without exerting excessive pressure on the ground. To increase speed with which fields can be planted, planters are becoming wider and the seed hoppers that feed the row units are becoming larger.

Different crops may be planted with different spacing between rows (which may be referred to in the art as “row spacing” or “row width”). When changing from one crop to another with a different row spacing, row units are physically moved along a toolbar of a planter implement. Some row units are removed entirely from the implement for wider spacing, or added for narrower spacing. Moving row units can be a time-consuming process, and if not performed carefully, can cause damage to the implement and/or the row units, and can lead to spacing errors.

### BRIEF SUMMARY

In some embodiments, an agricultural implement includes a toolbar, a plurality of receivers fixed to the toolbar, a plurality of row unit supports, and a plurality of alignment pins. Each receiver defines a notch and a through-hole, and each row unit support includes a shaft and defines a through-hole. The through-hole of the row unit support is configured to align with the through-hole of a respective receiver when the shaft rests in the notch of the respective receiver. Each alignment pin is configured to lock a row unit support to the respective receiver when the through-holes are aligned and the shaft rests in the notch.

The row unit supports may include two parallel plates connected by the shaft. Another shaft may also connect the parallel plates.

The row unit supports typically carry row units that include ground-engaging tools. The row units may be planter row units or fertilizer row units, for example. Each row unit may be coupled to a respective row unit support by a parallel linkage.

Each receiver is fixed to the toolbar, such as by at least one clamp. The receivers may each include two parallel plates. The receivers may have at least one shaft connecting the parallel plates, and the shaft may define the through-hole of the receiver.

The alignment pins may each comprise, for example, a bolt and a corresponding nut, a cotter pin, a clevis pin, or any other type of alignment device.

The toolbar may have a first section and at least one wing section hingedly coupled to the first section. At least one wheel may support the toolbar in an agricultural field.

A method of configuring the agricultural implement includes removing at least some of the alignment pins to unlock at least some of the row unit supports from corresponding receivers. The unlocked row unit supports are lifted to remove the row unit supports from the corresponding receivers.

At least some of the receivers may be moved laterally along the toolbar, and then fixed to the toolbar in different positions. For example, at least one clamp may be loosened, then retightened in the new position.

The method may also include placing at least some of the removed row unit supports in corresponding receivers, and installing alignment pins to lock the replaced row unit supports in place.

Within the scope of this application it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified top view of a tractor pulling an implement;

FIG. 2 is a simplified perspective view of a row unit and a receiver to hold the row unit;

FIG. 3 is a simplified perspective view of the receiver and a row unit support;

FIG. 4 is a simplified perspective view of the row unit support of FIG. 3 attached to the receiver;

FIG. 5 is a simplified side view illustrating how the row unit support of FIG. 3 is installed on the receiver;

FIG. 6 illustrates row units attached to receivers, and illustrates how row unit spacing can be changed by removing some row units and moving other row units; and

FIG. 7 illustrates a method of configuring the implement shown in FIG. 1.

### DETAILED DESCRIPTION

The illustrations presented herein are not actual views of any implement or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

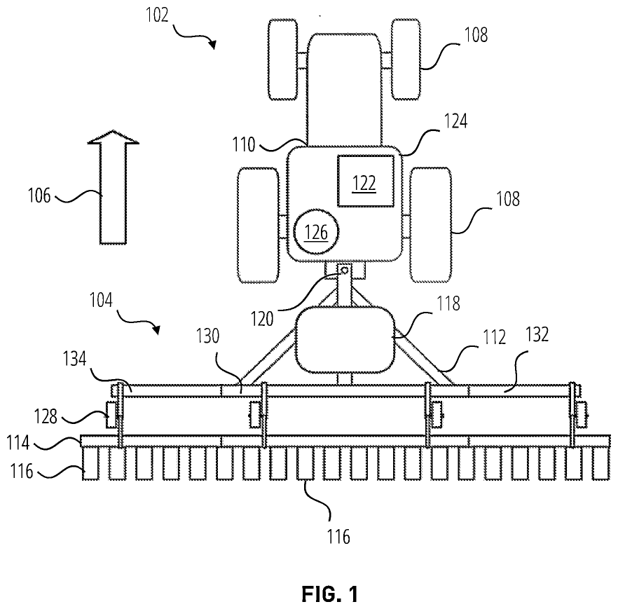

FIG. 1 illustrates a tractor 102 drawing an agricultural implement 104 in a forward direction 106. The tractor 102 has wheels 108, an engine, a chassis 110, and other elements as known in the art. The implement 104 has a frame 112 carrying a toolbar 114 supporting row units 116. The row units 116 are connected to a central hopper 118 containing seed to be planted and/or fertilizer to be applied. That is, the row units 116 may be planter and/or fertilizer row units of any design, which are generally known in the art. The implement 104 is connected to the tractor 102 by a tow hitch 120. A computer 122, which may include a central processing unit (“CPU”), memory, implement controller, and graphical user interface (“GUI”) (e.g., a touch-screen interface), is typically located in an operator cabin 124 of the tractor 102. A global positioning system GPS receiver 126 may be mounted to the tractor 102 and connected to communicate with the computer 122. The implement controller is configured to communicate with the row units 116 and/or the GPS receiver 126, such as by wired or wireless communication.

The implement 104 may be supported in the field by at least one wheel 128 coupled to the frame 112. The frame 112 may include a first section 130 (e.g., a center section) configured to be towed by the tractor 102, and one or more wing sections 132, 134 hingedly coupled to the first section 130. For example, and as shown in FIG. 1, the first section 130 may be a center section, and two wing sections 132, 134 may be attached to opposite sides thereof. The wing sections 132, 134 may fold for transport or storage, and unfold (as shown in FIG. 1) for planting, fertilizing, or other field operations. Typically, the wheels 128 may support any or all of the wing sections 132, 134. In other embodiments, the center section 130 may be omitted, and two wing sections 132, 134 may be connected directly to one another. In still other embodiments, the frame 112 may be a single rigid body (i.e., that does not fold for transport).

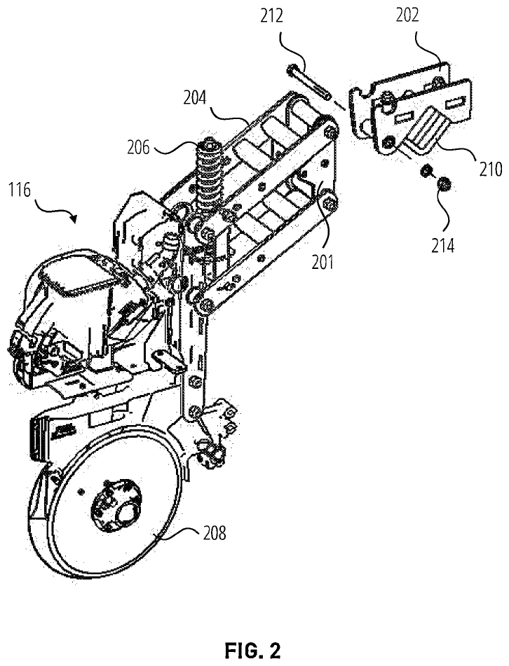

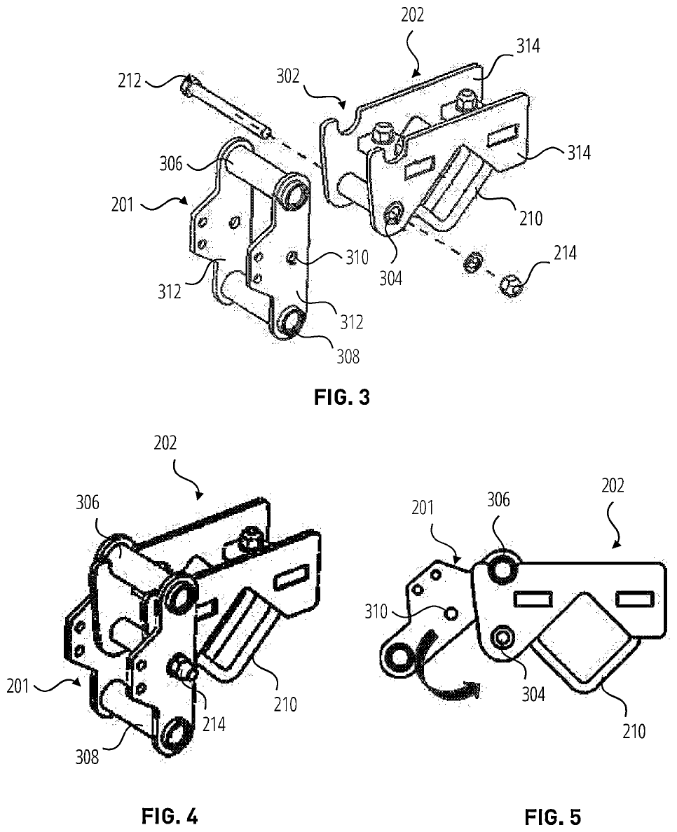

FIG. 2 is a simplified perspective view of a single row unit 116 with a row unit support 201, and a receiver 202 through which the row unit support 201 can be attached the toolbar 114 (toolbar 114 shown in FIG. 1 but omitted from FIG. 2). FIG. 3 shows the row unit support 201 and the receiver 202 without the row unit 116. FIG. 4 shows the row unit support 201 secured to the receiver 202.

Each of the row units 116 is connected to a respective row unit support 201 by any known method. For example, and as shown in FIG. 2, the row unit 116 may be connected to the row unit support 201 by a parallel linkage 204 and a spring 206, to enable the height of the row unit 116 to change relative to the toolbar 114. Other attachment methods may alternatively be used. The row unit 116 includes one or more ground-engaging tool 208, which is depicted generally in FIG. 2 as opening discs for a planter. The row unit 116 may also include other elements, such as a seed meter, a seed reservoir, closing discs, coulters, plough shanks, disc harrows, etc.

The receiver 202 may be fixed to the toolbar 114 by one or more clamps 210 (e.g., two) and corresponding hardware (e.g., nuts and/or bolts). The receiver 202 may include, for example, two parallel metal plates 314 connected to one another by shafts, bars, brackets, etc. The receiver 202 defines a notch 302 and a through-hole 304 for attaching a receiver 202 to the receiver 202. For example, the through-hole 304 may be a hole through a shaft connecting plates 314 of the receiver 202. In the implement 104 shown in FIG. 1, the toolbar 114 may carry at least as many receivers 202 as row units 116, such that each of the row units 116 can be attached to a receiver 202.

The row unit support 201 includes one or more shafts 306, 308. The shafts 306, 308 may connect two parallel metal plates 312, providing rigidity and structure to the row unit support 201. The shaft 306 is configured to rest within the notch 302 of the receiver 202, as shown in FIG. 4.

A through-hole 310 is formed in the row unit support 201. For example, the through-hole 310 can include two holes drilled through each of the two metal plates 312 of the row unit support 201. When the row unit support 201 is in position with the top shaft 306 in the notch 302, an alignment pin (i.e., a bolt 212) can pass through the through-holes 304, 310 to lock the row unit support 201 to the receiver 202. A nut 214 can be secured to the bolt 212 to prevent accidental removal of the bolt 212. In other embodiments, the alignment pin may include a cotter pin, a clevis pin, or any other type of alignment device.

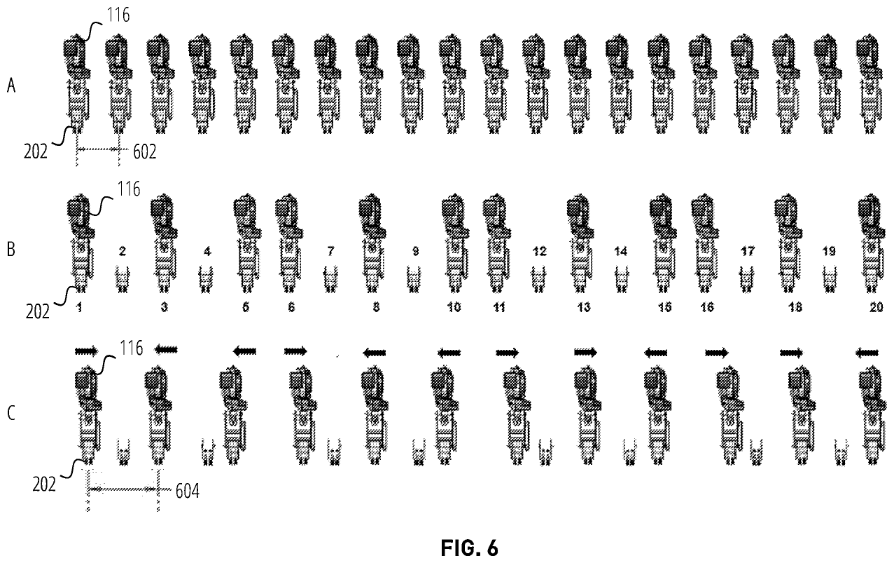

FIG. 5 is a side view depicting how the row unit support 201 is installed on the receiver 202. The shaft 306 may be placed within the notch 302, and the row unit support 201 can rotate to a position in which the through-hole 310 of the row unit support 201 aligns with (i.e., is concentric with) the through-hole 304 of the receiver 202. An operator can insert the bolt 212 into the through-holes 310, 304, and screw the nut 214 onto the bolt 212. To remove the row unit 116, the operator can remove the bolt 212, and rotate and lift the row unit support 201. The row unit support 201 is released from the receiver 202. Thus, if not all of the row units 116 are needed for a particular field operation, and the operator wishes to decrease the weight of the implement 104, some of the row units 116 can be removed with just one nut 214 and bolt 212 per row unit 116. Installation and removal of row unit support 201 from the receiver 202 may be faster and less labor-intensive than conventional methods of installing and removing row units. For example, doubling row unit spacing may be quickly and easily performed by simply removing alternating row units 116, leaving the receivers 202 in place.

The vacant receivers 202 remaining on the toolbar 114 when a row unit 116 is removed may weigh substantially less than the row units 116 themselves, and so removing the row units 116 may substantially decrease the weight of the implement 104. Furthermore, because the receivers 202 may be left in place on the toolbar 114, realigning the row units 116 back in the selected position is simplified.

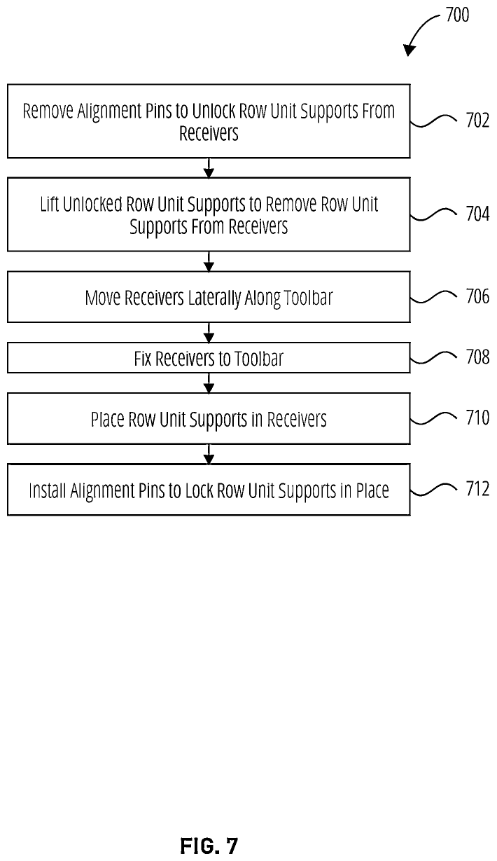

The system as shown in FIG. 2 may also be used to change the spacing between row units 116 on the toolbar 114. FIG. 6 illustrates how the spacing may be changed by removing some row units 116 from the toolbar 114 and moving other row units 116 along the toolbar 114. The top line (line A) of FIG. 6 shows twenty (20) row units 116 spaced at a first spacing 602 (e.g., 450 mm center-to-center) along the toolbar 114 (omitted from view in FIG. 6, but shown in FIG. 1). To convert the implement 104 to a different spacing 604 shown in the bottom line (line C), some of the row units 116 are first removed as explained above. For example, and as shown in the middle line (line B), eight (8) row units 116 in positions 2, 4, 7, 9, 12, 14, 17, and 19 may be removed. The remaining twelve (12) row units 116 may be moved along the toolbar 114 to the left or right such that the remaining row units 116 are spaced at the second spacing 604 (e.g., 760 mm center-to-center).

To move the remaining row units 116, the row units 116 may optionally be removed as explained above. The clamps 210 may be loosened enough to enable the receivers 202 to slide along the toolbar 114. The clamps 210 may be tightened once the receivers 202 are in the correct position, and the row units 116 may be reinstalled. The receivers 202 for row units 116 that are not replaced (e.g., in positions 2, 4, 7, 9, 12, 14, 17, and 19 in the example in FIG. 6) need not be moved because they may be small enough to not interfere with the remaining row units 116 (whereas, the unused row units 116, had they been left in place on the toolbar 114, may interfere with the new positions of the operating row units 116 at their new locations).

Removing each row unit 116 may be performed, as discussed above, with the removal of a single alignment pin (i.e., nut 214 and bolt 212). Movement of each receiver 202 may be performed by loosening and tightening one clamp 210, which may typically have two nuts. Thus, to convert from the 20-row spacing 602 in line A of FIG. 6 to the 12-row spacing 604 in line C of FIG. 6, an operator may remove 20 alignment pins, loosen 24 nuts, slide 12 receivers 202 along the toolbar 114, tighten the 24 nuts, and reinstall the 12 of the 20 alignment pins corresponding to the 12 row units 116. In other embodiments, the receivers 202 may be moved laterally along the toolbar 114 without removing the row units 116, and thus, the change may only require removing 8 alignment pins, loosening 24 nuts, sliding 12 receivers 202, and tightening the 24 nuts. In either scenario, the process may be faster and easier than changing row unit spacing on conventional implements. Furthermore, the easy removal of the unused row units 116 (e.g., in positions 2, 4, 7, 9, 12, 14, 17, and 19 in the example in FIG. 6) enables movement of the remaining row units 116 to their proper positions, without interference from the unused and removed row units 116.

In other embodiments, the toolbar 114 may carry additional receivers 202, such that the row unit spacing can be changed without moving any receivers 202. For example, a toolbar 114 accommodating the configurations shown in both of lines A and C of FIG. 6 may carry thirty-two (32) receivers 202, corresponding to the locations in each of the 20-row and 12-row configurations. Row units 116 may simply be installed on the appropriate set of receivers 202 to match the selected spacing. Such an arrangement of receivers 202 may be particularly useful for implements that are routinely changed between two configurations.

FIG. 7 is a simplified flow chart illustrating a method 700 of configuring an agricultural implement, such as the implement 104 shown in FIG. 1.

In block 702, alignment pins are removed from at least some of the row unit supports to unlock the row unit supports from corresponding receivers. For example, if the alignment pins are in the form a bolt and a nut, the nut is removed, and the bolt slides out of the through-holes.

In block 704, an operator lifts the unlocked row unit supports to remove the row unit supports (and the attached row units) from the corresponding receivers. The operator may also rotate or tilt the row unit supports before or during lifting.

In block 706, the operator moves at least some of the receivers laterally along the toolbar such that the receivers are at a new selected spacing. Some of the receivers may be left in place. To move the receivers, clamps holding the receivers to the toolbar may be loosened, such as by loosening one or more nuts or bolts. The operator fixes the moved receivers to the toolbar, as depicted in block 708, such as by tightening the clamp.

In block 710, at least some of the removed row unit supports are placed in receivers. The alignment pins are reinstalled to lock the replaced row unit supports in place, shown in block 712.

Though depicted as a flow chart, the actions in FIG. 7 may be performed concurrently, and in some embodiments, some actions may be omitted.

All references cited herein are incorporated herein in their entireties. If there is a conflict between definitions herein and in an incorporated reference, the definition herein shall control.

1. An agricultural implement, comprising:
a toolbar;
a plurality of receivers fixed to the toolbar, each receiver defining a notch and a through-hole;
a plurality of row unit supports, each row unit support comprising a shaft and defining a through-hole, wherein the through-hole is configured to align with the through-hole of a respective receiver of the plurality of receivers when the shaft rests in the notch of the respective receiver;
a plurality of alignment pins, each configured to lock a row unit support to the respective receiver when the through-holes are aligned and the shaft rests in the notch.

2. The implement of claim 1, wherein the alignment pins each comprise a bolt and a corresponding nut.

3. The implement of claim 1, wherein each row unit support carries a row unit comprising a ground-engaging tool.

4. The implement of claim 3, wherein each row unit is coupled to a respective row unit support by a parallel linkage.

5. The implement of claim 3, wherein each row unit comprises a planter row unit.

6. The implement of claim 3, wherein each of the row units comprises a fertilizer row unit.

7. The implement of claim 1, wherein each row unit support comprises two parallel plates connected by the shaft.

8. The implement of claim 7, further comprising another shaft connecting the parallel plates.

9. The implement of claim 1, wherein each receiver is fixed to the toolbar by at least one clamp.

10. The implement of claim 1, wherein each receiver comprises two parallel plates.

11. The implement of claim 10, wherein each receiver further comprises at least one shaft connecting the parallel plates, wherein the shaft defines the through-hole of the receiver.

12. The implement of claim 1, wherein the toolbar comprises a first section and at least one wing section hingedly coupled to the first section.

13. The implement of claim 1, wherein the toolbar is supported by at least one wheel.

14. A method of configuring the agricultural implement of claim 1, the method comprising:
removing at least some of the alignment pins to unlock at least some of the row unit supports from corresponding receivers; and
lifting the unlocked row unit supports to remove the row unit supports from the corresponding receivers.

15. The method of claim 14, further comprising:
moving at least some of the receivers laterally along the toolbar; and
fixing the moved receivers to the toolbar.

16. The method of claim 15, wherein moving at least some of the receivers along the toolbar comprises loosening at least one clamp fixing each of the at least one receiver to the toolbar.

17. The method of claim 16, wherein fixing the moved receivers to the toolbar comprises tightening the at least one clamp.

18. The method of claim 1, further comprising:
placing at least some of the removed row unit supports in corresponding receivers; and
installing alignment pins to lock the replaced row unit supports in place.
